(19) United States
(12) Patent Application Publication
(10) Pub. No.: US 2008/0211233 A1
(43) Pub. Date: Sep. 4, 2008

(54) Water Turbine in Tethered Asymmetric Nozzle

(76) Inventor: Francis Allen Farrelly, Roma (IT)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 11/913,314

(22) PCT Filed: May 4, 2006
(86) PCT No.: PCT/IT2006/000313

§ 371 Date: Nov. 1, 2007

(30) Foreign Application Priority Data
May 5, 2005 (IT) RM2005A000216

(51) Int. Cl. F03B 13/12; F03B 3/04; F03B 11/08

(52) U.S. Cl. 290/54; 415/7; 415/121.2

(57) ABSTRACT

The object of description is an energy generating device for harnessing submarine currents composed of an asymmetric nozzle capable of directing the water flow towards one or more turbines placed (5) before the said nozzle's outlet (4). The nozzle's inlet is asymmetric in shape; one surface of the aforementioned inlet extends beyond its opposite surface, thus acting as a lifting surface producing a force with a component perpendicular to the current flow. The device is moored with a tether-line system (7) which enables the said device to remain in equilibrium, by counteracting the vertical component of the tether's tension, with the vertical lift due to the water flowing through the asymmetric nozzle.

Harnessing hydro-potential energy with hydroelectric power plants in dams is still the most successful example of energy produced from renewable sources, even though these power plants have a heavy impact on both the environmental ecosystem and on human activities. A growing trend in the field of renewable energy extraction is that of adopting strategies which are both effective and have limited environmental impact. Submarine hydrokinetic power plants which harness energy from marine currents have these characteristics.

These latter systems offer multiple advantages, notably:
1. reliable energy production forecasts due to the relatively constant current velocity;
2. absence of sudden changes in the flow velocity which are a critical aspect in the wind energy conversion systems;
3. reduced environmental impact.

Among the drawbacks related to these systems are:
1. complexity of deployment operations;
2. difficult and expensive maintenance operations;
3. harsh operational environment.

Hydrokinetic power units are generally secured by one of two means;
a) power units which are fixed to the sea-bed (e.g. with foundations);
b) power units moored to the sea-bed with tether lines, which are thus relatively mobile.

In comparison to fixed sea-bed installations, tethered units, such as the device object of this patent, can noticeably reduce the above mentioned drawbacks. Indeed, the variable depths and optimal orientation offered by adjustable deployment in operational conditions enables the current flow to be best exploited. Insofar as maintenance operations are concerned, tethered units may be raised to the surface greatly simplifying these procedures thus reducing their expense in comparison to fixed sea-bed installations. Furthermore, by facilitating maintenance procedures, the impact of corrosion related issues may be greatly reduced.

The mobile nature of tethered units implies, on the other hand, that an appropriate means of ensuring hydrodynamic stability must be sought as, the tension applied to the mobile unit by the tether line introduces a variable force whose downward component is also a function of the power produced by the device; this may lead to serious operational failures. Several methods have been proposed for achieving hydrodynamic stability, amongst these are those based on hydrofoil surfaces (e.g. see patent n. WO0042318) which in this invention are embodied by the asymmetric surfaces of the nozzle which provide the required lifting force.

This device possesses the characteristics required to best achieve hydrodynamic stability and resolve its adverse effects.

Another aspect which is tackled by this invention is related to the issue of the marine current flow velocity.

Marine current flow velocities are generally not particularly high; exploiting a nozzle to collect a greater portion of the flow to the turbine, used to convert hydrokinetic energy into mechanical energy, enables smaller turbines to be employed with respect to devices without nozzles, thus improving its usefulness and economical viability.

Despite the great potential held by such devices, production of electrical energy by this means is not, for the moment, economically viable as the construction costs of systems with separate nozzle and hydrofoil components is considerable. The innovative hybrid hydrofoil-nozzle solution, introduced by this invention, ensures a more economical design by integrating these two essential functions in a single structure.

The object of this invention, described below, integrates these two functions; indeed the use of a nozzle with asymmetric convergent surfaces, both directs the flow to the turbine and produces a force perpendicular to the flow; such an asymmetric nozzle, acting as a hybrid-hydrofoil nozzle, enables hydrodynamic stability to be achieved, while allowing, at the same time, smaller turbines to be employed.

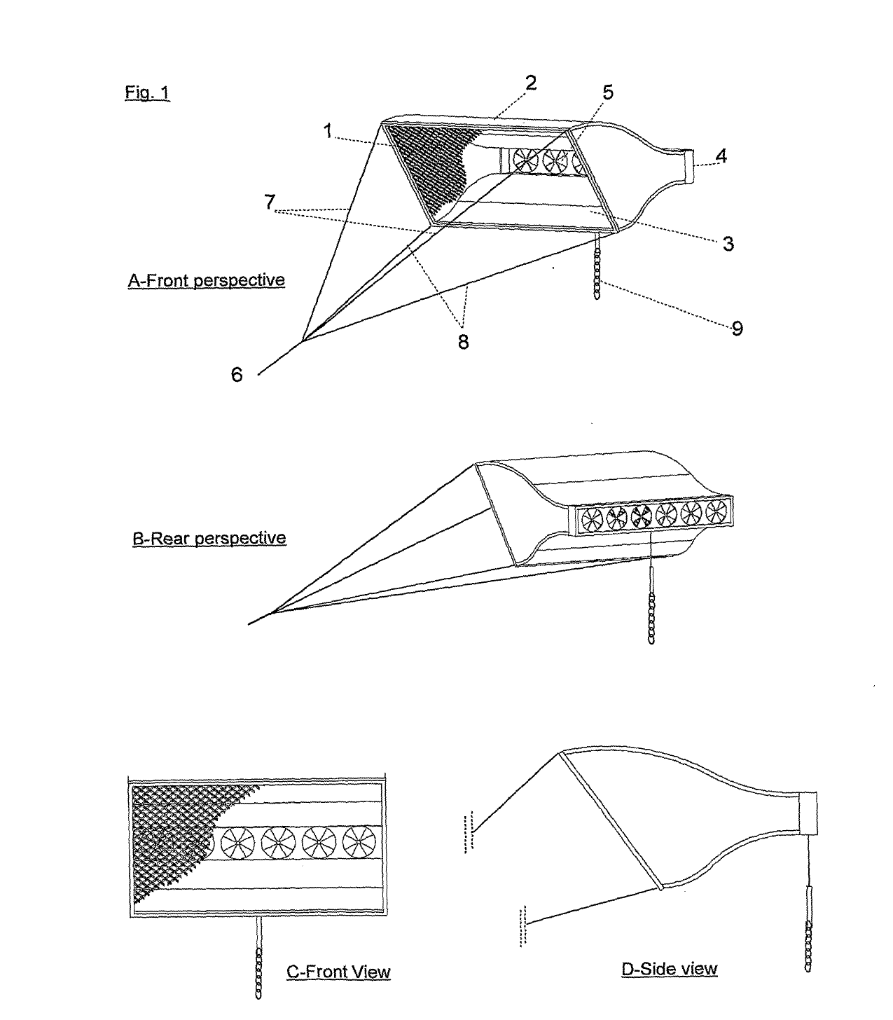

One embodiment of this invention, is shown in FIG. 1; it is composed of a mobile unit, and a tethered mooring system. This tethered power unit is itself composed of: a protective grill (1) enclosing the nozzle's rectangular convergent inlet section; an upper surface (2) of the said inlet section overhanging its lower surface (3); a divergent outlet section of the nozzle fitted with multiple outlets (4) each serving a turbine (5). The tethering system is composed of a tether line having one extremity (6) fixed to the sea-bed and the other extremity divided into 4 stays; two of these stays (7) are fastened to the outer extremes of the upper surface of the inlet, one on each side, while the other two (8) are similarly placed on the on the outer extremes of the lower inlet surface. The flow of the current through the asymmetric nozzle tends to keep it aligned in the general direction of the flow and, as the water flow converges in the nozzle inlet, its velocity incident at the water turbine is increased. The overhanging section of the inlet tends to deflect a greater portion of the flow and thus the device is subject to a force perpendicular to the flow.

This vertical lifting force counteracts the vertical downward component of the mooring tether line. Finally, were the hydrodynamic lift to be insufficient, a chain acting as a ballast (9), would allow the unit to sink to a preset minimum elevation above the sea-bed as the structure reaches it hydrostatic equilibrium.

In practice details in the execution may vary while still in keeping with the invention and thus in the patent scope.

1-12. (canceled)

13. An adjustably deployable device for generating mechanical energy exploiting the hydrokinetic energy of water currents, said adjustably deployable device comprising:
a mobile unit comprising a nozzle, and at least one water turbine positionable inside said nozzle, said nozzle having at least two extremities, a first being an inlet section facing oncoming flow of the current and capable of converging the oncoming water flow towards a second extremity, said second extremity being an outlet section and thus facing the downstream flow of the current, said inlet section of said nozzle having an asymmetry between its opposing upper and lower surfaces such as to produce a force with a component perpendicular to the flow, said water turbine being adapted for converting hydrokinetic energy into mechanical energy; and
a mooring system having a first extremity fixed to a point stationary with respect to the flow of the water current, and a second extremity fixed to said mobile unit;
wherein said mooring system produces a force with a component which is perpendicular to the flow and furthermore is dependent on the elevation of said mobile unit, said asymmetry in said nozzle being adapted to contrast said force so as to obtain a stabilization effect of said mobile unit thereby maintaining said mobile unit at a nearly constant elevation above a sea bed.

14. The adjustably deployable device according to claim 13, wherein said inlet section of said nozzle is asymmetric in that its entrance rim is characterized by two parts, one extending out further than its opposite, resulting therefore, in a force with a component perpendicular to direction of the water flow.

15. The adjustably deployable device according to claim 13, wherein said second extremity of said mooring system being subdivided into multiple elements fixed to said mobile unit, and further comprising fastening points attachable to each of said elements and positionable on said mobile unit so that the allotment of the tensions applied by said elements to said fastening points shall seek to return to equilibrium in the event of changes thereof.

16. The adjustably deployable device according to claim 13, wherein said mobile unit being adapted such that the center of buoyancy does not coincide with the center of mass of said mobile unit, thereby ensuring said mobile unit's hydrostatic stability, with the aim of maintaining optimal trim with respect to the water flow.

17. The adjustably deployable device according to claim 13 further comprising a ballast suspendable below said mobile unit for allowing said mobile unit to reach a minimum elevation above the sea floor, were the water flow velocity to be insufficient in providing lift to said mobile unit, said ballast allows said mobile unit to position itself favorably for returning to operational depth once water current velocity returns to sufficiently high values.

18. The adjustably deployable device according to claim 17, wherein said ballast is a chain.

19. The adjustably deployable device according to claim 13 further comprising a protection system attachable to said inlet section of said asymmetric nozzle, said protection system being adapted to avoid the influx of material towards said water turbine.

20. The adjustably deployable device according to claim 18, wherein said protection system is composed of a grill which, by exploiting the asymmetry of said inlet section of said nozzle, presents a surface oblique to the general flow of the current thus acting as a slip surface for any potentially harmful objects, favoring their disposal.

21. The adjustably deployable device according to claim 13 further comprising at least one elevator attachable to said mobile unit for controlling the pitch of said mobile unit.

22. The adjustably deployable device according to claim 13 further comprising at least one aileron attachable to said mobile unit for controlling the roll of said mobile unit.

23. The adjustably deployable device according to claim 13 further comprising at least one rudder attachable to said mobile unit for controlling the yaw of said mobile unit, with respect to the current flow.

24. The adjustably deployable device according to claim 13 further comprising a movable ballast attachable to said mobile unit for controlling the trim of said mobile unit.

25. The adjustably deployable device according to claim 13, wherein said deployable device further comprising of an assembly of multiple deployable devices.

26. A tethered water turbine system comprising:
a mobile unit comprising a nozzle, and at least one water turbine positionable inside said nozzle, said nozzle having at least two extremities, a first being an inlet section facing oncoming flow of the current and capable of converging the oncoming water flow towards a second extremity, said second extremity being an outlet section and thus facing the downstream flow of the current, said inlet section of said nozzle having an asymmetry between its opposing upper and lower surfaces such as to produce a force with a component perpendicular to the flow, said water turbine being adapted for converting hydrokinetic energy into mechanical energy;
a mooring system having a first extremity fixed to a point stationary with respect to the flow of the water current, and a second extremity fixed to said mobile unit, said second extremity being at least two stays attachable to said mobile unit; and
a ballast attachable to said mobile unit;
wherein said inlet section of said nozzle is asymmetric in that its entrance rim is characterized by two parts, one extending out further than its opposite, resulting therefore, in a force with a component perpendicular to direction of water flow.

27. The tethered water turbine system according to claim 26, wherein said mobile unit being adapted such that the center of buoyancy does not coincide with the center of mass of said mobile unit, thereby ensuring said mobile unit's hydrostatic stability, with the aim of maintaining optimal trim with respect to the water flow.

28. The tethered water turbine system according to claim 26, wherein said ballast is suspended below said mobile unit for allowing said mobile unit to reach a minimum elevation above the sea floor, were the water flow velocity to be insufficient in providing lift to said mobile unit, said ballast allows said mobile unit to position itself favorably for returning to operational depth once water current velocity returns to sufficiently high values.

29. The tethered water turbine system according to claim 26 further comprising a grill attachable to said inlet section of said nozzle, said grill being adapted to exploit the asymmetry of said inlet section of said nozzle by presenting a surface oblique to the general flow of the current thus acting as a slip surface for any potentially harmful objects, favoring their disposal.

30. The tethered water turbine system according to claim 26 further comprising at least one elevator attachable to said mobile unit for controlling the pitch of said mobile unit, at least one aileron attachable to said mobile unit for controlling the roll of said mobile unit, and at least one rudder attachable to said mobile unit for controlling the yaw of said mobile unit, with respect to the current flow.

31. The tethered water turbine system according to claim 26, wherein said ballast is a chain.

32. A tethered water turbine system comprising:
a mobile unit comprising a nozzle, and at least one water turbine positionable inside said nozzle, said nozzle having at least two extremities, a first being an inlet section facing oncoming flow of the current and capable of converging the oncoming water flow towards a second extremity, said second extremity being an outlet section and thus facing the downstream flow of the current, said inlet section of said nozzle having an asymmetry between its opposing upper and lower surfaces such as to produce a force with a component perpendicular to the flow, said water turbine being adapted for converting hydrokinetic energy into mechanical energy, said inlet section of said nozzle is asymmetric in that its entrance rim is characterized by two parts, one extending out further than its opposite, resulting therefore, in a force with a component perpendicular to direction of water flow;
a mooring system having a first extremity fixed to a point stationary with respect to the flow of the water current, and a second extremity fixed to said mobile unit, said second extremity being at least two stays attachable to said mobile unit;
a ballast attachable to said mobile unit; and
a grill attachable to said inlet section of said nozzle, said grill being adapted to exploit the asymmetry of said inlet section of said nozzle by presenting a surface oblique to the general flow of the current thus acting as a slip surface for any potentially harmful objects.
